(19) United States
(12) Patent Application Publication
(10) Pub. No.: US 2006/0148478 A1
(43) Pub. Date: Jul. 6, 2006

(54) System and method for transmitting/receiving automatic repeat request reset information in a communication system

(75) Inventors: Hye-Yeon Jeong, Suwon-si (KR); Sung-Wook Park, Seongnam-si (KR); Yun-Sung Kim, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO. LTD., Gyeonggi-do (KR)

(21) Appl. No.: 11/326,196

(22) Filed: Jan. 5, 2006

(30) Foreign Application Priority Data
Jan. 5, 2005 (KR) 853/2005

(51) Int. Cl. H04Q 7/20

(52) U.S. Cl. 455/436

(57) ABSTRACT

A method for transmitting/receiving Automatic Repeat reQuest (ARQ) reset information in a communication system. A mobile station (MS) performs handover to a target base station (BS). Upon detecting the handover of the MS, the target BS transmits ARQ reset information representative of information related to ARQ reset to the MS. The MS receives the ARQ reset information from the target BS.

### PRIORITY

This application claims the benefit under 35 U.S.C. § 119(a) of an application filed in the Korean Intellectual Property Office on Jan. 5, 2005 and assigned Serial No. 2005-853, the entire contents of which are incorporated herein by reference.

### BACKGROUND OF THE INVENTION

1. Field of the Invention

The present invention relates generally to a communication system, and in particular, to a system and method for transmitting/receiving Automatic Repeat reQuest (ARQ) reset information during handover of a mobile station (MS).

2. Description of the Related Art

The next generation communication system has developed into a packet service communication system. The packet service communication system, a system for transmitting burst packet data to a plurality of MSs, has been designed to be suitable for high-capacity, high-speed data transmission. In order to make the high-capacity, high-speed data transmission possible, it is necessary to minimize possible data loss occurring due to a bad channel state, i.e., due to noise, interference and fading of a channel. Various error control schemes are used to minimize the data loss, and an Automatic Repeat reQuest (ARQ) scheme is a typical error control scheme.

The next generation communication system is evolving into an advanced system that guarantees mobility and quality-of-service (QoS) for a Broadband Wireless Access (BWA) communication system, such as a wireless Local Area Network (LAN) communication system and a wireless Metropolitan Area Network (MAN) communication system, for high-capacity and high-speed data communication. An Institute of Electrical and Electronics Engineers (IEEE) 802.16e communication system is a typical advanced communication system.

The IEEE 802.16e communication system is specified as a communication system employing an Orthogonal Frequency Division Multiplexing (OFDM) scheme and/or an Orthogonal Frequency Division Multiple Access (OFDMA) scheme (OFDM/OFDMA communication system) to support broadband transmission for physical channels of the wireless MAN communication system. A configuration of the conventional IEEE 802.16e communication system will now be described with reference to the diagram of FIG. 1.

Referring to FIG. 1, the IEEE 802.16e communication system has a multicell configuration, i.e., has a cell 100 and a cell 150. The IEEE 802.16e communication system includes a base station (BS) 110 for managing the cell 100, a BS 140 for managing the cell 150, and a plurality of MSs 111, 113, 130, 151 and 153. Signal exchange between the BSs 110 and 140 and the MSs 111, 113, 130, 151 and 153 is achieved using the OFDM/OFDMA scheme.

A description will now be made of a method of transmitting/receiving a signal using the ARQ scheme in the IEEE 802.16e communication system. For convenience, the method of transmitting/receiving a signal using the ARQ scheme will be referred to as an “ARQ signal transmission/reception operation.”

An MS, upon power-on, performs a network entry operation with a BS, or performs a network re-entry operation with a target BS for handover. While performing the network entry operation or the network re-entry operation, the MS determines whether to use the ARQ scheme and negotiates on parameters related to the use of the ARQ scheme (ARQ parameters) if the ARQ scheme is used, in the process of connecting a service flow after completing its registration in a corresponding BS. The term “service flow” refers to a flow in which a Medium Access Control (MAC) Service Data Unit (SDU) is transmitted/received through a connection having a particular QoS type.

With reference to the signaling diagram of FIG. 2, a description will now be made of a network re-entry operation in a conventional IEEE 802.16e communication system.

Referring to FIG. 2, if an MS 200, while performing a service with a serving BS 220 in step 201, determines to perform handover to another BS other than the serving BS 220, i.e., a target BS 250 in step 203, it performs a handover operation with the target BS 250 in step 205. After completion of handover to the target BS 250, the MS 200 acquires downlink (DL) synchronization with the target BS 250 and receives parameters to be used in a downlink and an uplink (UL) in step 211. Thereafter, the MS 200 must perform an operation of acquiring uplink synchronization and adjusting transmission power by performing a ranging operation with the target BS 250. Therefore, the MS 200 transmits a Ranging Request (RNG-REQ) message to the target BS 250 in step 213, and the target BS 250 transmits a Ranging Response (RNG-RSP) message to the MS 200 in response to the RNG-REQ message in step 215.

After performing the ranging operation, the MS 200 transmits a Subscriber station Basic Capability Request (SBC-REQ) message to the target BS 250 to negotiate on its basic capability with the target BS 250 in step 217. Herein, the SBC-REQ message, a MAC message transmitted by the MS 200 for negotiation on the basic capability with the target BS 250, includes information on a modulation and coding scheme supported by the MS 200. Upon receiving the SBC-REQ message from the MS 200, the target BS 250 detects the modulation and coding scheme supported by the MS 200, included in the received SBC-REQ message, and then transmits a Subscriber Station Basic Capability Response (SBC-RSP) message to the MS 200 in response to the SBC-REQ message in step 219.

Upon receiving the SBC-RSP message, the MS 200 transmits a Privacy Key Management Request (PKM-REQ) message to the target BS 250 for MS authentication and key exchange in step 221. Herein, the PKM-REQ message, a MAC message for authentication on the MS 200, includes a certificate (unique information) of the MS 200. Upon receiving the PKM-REQ message, the target BS 250 performs authentication with an authentication server (AS, not shown) using the certificate of the MS 200, included in the received PKM-REQ message. If the MS 200 passes the authentication, i.e., if the MS 200 is an authenticated MS, the target BS 250 transmits a Privacy Key Management Response (PKM-RSP) message to the MS 200 in response to the PKM-REQ message in step 223. Herein, the PKEM-RSP message includes an authentication key (AK) and a traffic encryption key (TEK) allocated to the MS 200.

Upon receiving the PKM-RSP message, the MS 200 transmits a Registration Request (REG-REQ) message to the target BS 250 in step 225. Herein, the REG-REQ message includes MS registration information of the MS 200. Upon receiving the REG-REQ message, the target BS 250 registers the MS 200 therein by detecting the MS registration information included in the received REG-REQ message, and transmits a Registration Response (REG-RSP) message to the MS 200 in response to the REG-REQ message in step 227. Herein, the REG-RSP message includes registration information of the registered MS.

After completion of registering the MS 200 therein, the target BS 250 performs provisioning on the service flows provided in the target BS 250. That is, the target BS 250 transmits a Dynamic Service Addition Request (DSA-REQ) message to the MS 200 in step 229. The MS 200, upon receiving the DSA-REQ message from the target BS 250, transmits a Dynamic Service Addition Response (DSA-RSP) message to the target BS 250 in response to the DSA-REQ message in step 231. Herein, an operation of transmitting/receiving the DSA-REQ message and the DSA-RSP message will be referred to as a “DSA message transaction operation.” Also, one DSA message transaction operation can set a QoS type for only one service flow. Therefore, if there are several QoS types supported by the target BS 250, the DSA message transaction operation should be performed according to the number of QoS types supported by the target BS 250 for each of the downlink and the uplink. In FIG. 2, the DSA message transaction operation is performed only once, by way of example.

After completion of the provisioning operation for the service flows, if the MS 200 enters a normal operation mode, an Internet protocol (IP) connection is set up between the MS 200 and the target BS 250, and management information is downloaded through the connected IP protocol in step 233. Thereafter, a service flow is connected between the MS 200 and the target BS 250 in step 235, and a corresponding service is performed in step 237. As described above, at a time when a service flow is connected between the MS 200 and the target BS 250, the MS 200 and the target BS 250 determine whether to use the ARQ scheme and negotiate on parameters related to the use of the ARQ scheme (ARQ parameters) if the ARQ scheme is used.

A description will now be made of ARQ_SYNC_LOSS_TIMEOUT used for detecting synchronization between an ARQ state machine of a transmission apparatus for transmitting signals and an ARQ state machine of a reception apparatus for receiving signals, among the ARQ parameters.

The ARQ_SYNC_LOSS_TIMEOUT represents a timer for counting the maximum time in which ARQ_TX_WINDOW_START of the ARQ state machine of the transmission apparatus and ARQ_RX_WINDOW_START of the ARQ state machine of the reception apparatus can have the same value until a mis-synchronization between the ARQ state machine of the transmission apparatus and the ARQ state machine of the reception apparatus is detected after actual data transmission/reception is activated. That is, the ARQ state machine of the transmission apparatus resets ARQ_SYNC_LOSS_TIMEOUT managed by the ARQ state machine when the ARQ_TX_WINDOW_START is updated. In addition, the ARQ state machine of the reception apparatus sets or resets ARQ_SYNC_LOSS_TIMEOUT managed by the ARQ state machine if data is received within a range of ARQ_RX_WINDOW_START and the received data is not repeatedly received data. That is, the ARQ state machine of the reception apparatus resets the ARQ_SYNC_LOSS_TIMEOUT if the received data is coincident with the ARQ_RX_WINDOW_START, and sets the ARQ_SYNC_LOSS_TIMEOUT, if the received data is not coincident with the ARQ_RX_WINDOW_START. When the ARQ_SYNC_LOSS_TIMEOUT expires because of the completed count of the maximum time, ARQ reset occurs, and the ARQ reset indicates that all information related to the ARQ signal transmission/reception is reset.

In this way, the ARQ state machine of the transmission apparatus and the ARQ state machine of the reception apparatus perform an ARQ signal transmission/reception operation according to ARQ_SYNC_LOSS_TIMEOUT independently managed by them. However, the current IEEE 802.16e communication system takes into account only the ARQ signal transmission/reception operation in a normal operation mode, and never takes into account the ARQ signal transmission/reception operation in a handover operation mode. Therefore, in the current IEEE 802.16e communication system, even though an MS performs handover, the ARQ state machine can never detect the handover of the MS.

That is, in the current IEEE 802.16e communication system, even though a serving BS fails to deliver information related to the ARQ signal transmission/reception of the MS to a target BS through a backbone, the MS continuously attempts ARQ signal transmission/reception with the target BS. However, as the target BS fails to receive information related to the ARQ signal transmission/reception of the MS from the serving BS, ARQ signal transmission/reception between the MS and the target BS cannot be smoothly performed, thus generating ARQ reset.

With reference to the signaling diagram of FIG. 3, a detailed description will now be made of an ARQ reset generated due to handover of the MS in a conventional IEEE 802.16e communication system.

Referring to FIG. 3, if an MS 300 performs handover to a target BS 350, all timers related to ARQ signal transmission/reception stop their operations. Thereafter, if the MS 300 completes handover to the target BS 350 and a service flow is connected between the MS 300 and the target BS 350 in step 311, all the timers related to ARQ signal transmission/reception restart their operations. That is, the MS 300 activates an ARQ state machine and transmits data to the target BS 350 in step 313. However, in the case where the target BS 350 fails to receive ARQ signal transmission/reception information of the MS 300 from a serving BS as described above, even though the MS 300 transmits data to the target BS 350, the target BS 350 cannot transmit feedback information therefor because it failed to receive the ARQ signal transmission/reception information of the MS 300. In addition, because the MS 300 fails to receive feedback information for the transmitted data from the target BS 350, both ARQ_SYNC_LOSS_TIMEOUT of the MS 300 and ARQ_SYNC_LOSS_TIMEOUT of the target BS 350 expire in steps 315 and 317, respectively. The expiration of the ARQ_SYNC_LOSS_TIMEOUT causes generation of ARQ reset between the MS 300 and the target BS 350 in step 319.

As described with reference to FIG. 3, after performing handover, an MS performs an unnecessary ARQ signal transmission/reception operation with a target BS until ARQ reset due to expiration of ARQ_SYNC_LOSS_TIMEOUT is generated. The unnecessary ARQ signal transmission/reception operation causes unnecessary resource waste and service delay.

### SUMMARY OF THE INVENTION

It is, therefore, an object of the present invention to provide a system and method for transmitting/receiving ARQ reset information in a communication system.

It is another object of the present invention to provide a system and method for exchanging ARQ reset information with a target BS during handover of an MS in a communication system.

According to one aspect of the present invention, there is provided a method for transmitting/receiving Automatic Repeat reQuest (ARQ) reset information in a communication system. A mobile station (MS) performs handover to a target base station (BS). Upon detecting the handover of the MS, the target BS transmits ARQ reset information representative of information related to ARQ reset to the MS. The MS receives the ARQ reset information from the target BS.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a conventional IEEE 802.16e communication system;

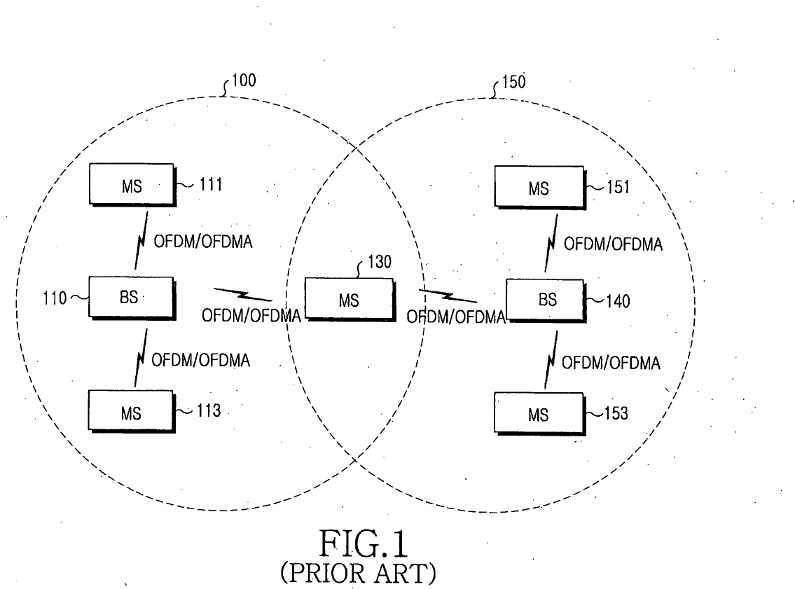

FIG. 2 is a signaling diagram illustrating a network re-entry operation in a conventional IEEE 802.16e communication system;

FIG. 3 is a signaling diagram illustrating an ARQ reset operation due to handover of an MS in a conventional IEEE 802.16e communication system; and

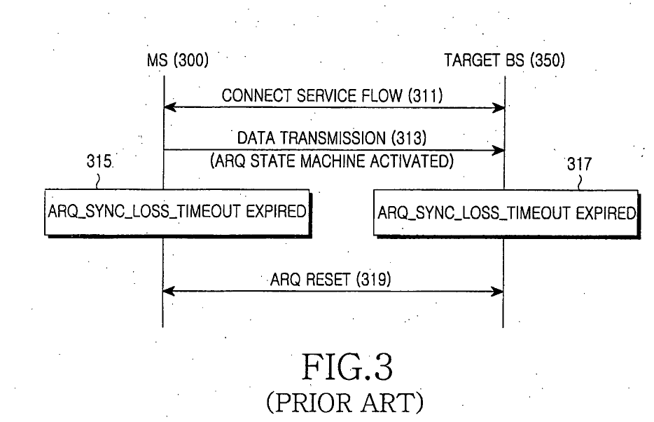

FIG. 4 is a signaling diagram illustrating an ARQ reset operation due to handover of an MS in an IEEE 802.16e communication system.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a system and method for transmitting/receiving Automatic Repeat reQuest (ARQ) reset information in a communication system. In addition, the present invention provides a system and method for exchanging ARQ reset information between a mobile station (MS) and a target base station (BS) during network re-entry of the MS in a communication system. For convenience, an embodiment of the present invention will be described with reference to an Institute of Electrical and Electronics Engineers (IEEE) 802.16e communication system, as an example of the foregoing communication system. The novel ARQ reset information transmission/reception system and method provided in the present invention can also be applied to other communication systems as well as the IEEE 802.16e communication system. In addition, an embodiment of the present invention will be described with reference to handover of an MS in the network re-entry operation.

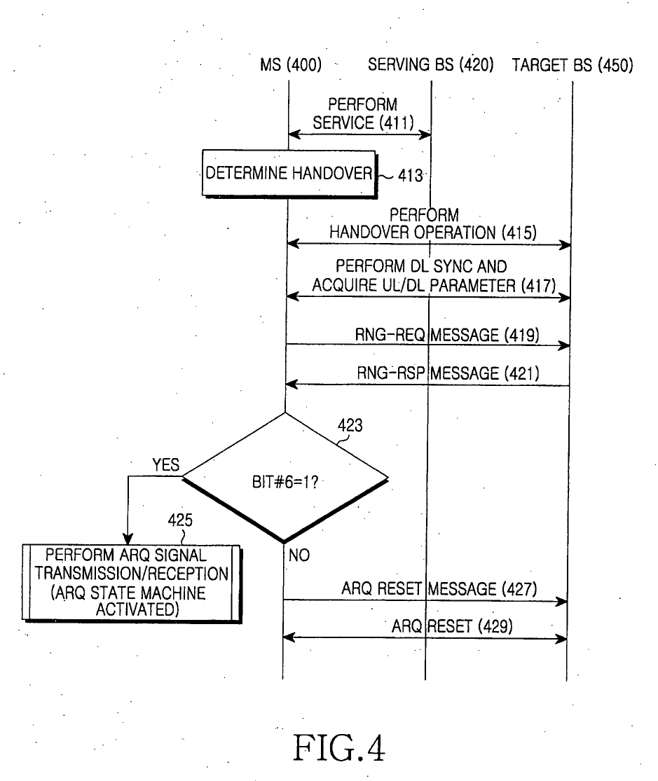

FIG. 4 is a signaling diagram illustrating an ARQ reset operation due to handover of an MS in an IEEE 802.16e communication system.

Referring to FIG. 4, if an MS 400, while performing a service with a serving BS 420 in step 411, determines to perform handover to another BS other than the serving BS 420, i.e., a target BS 450 in step 413, it performs a handover operation with the target BS 450 in step 415. After completion of handover to the target BS 450, the MS 400 acquires downlink (DL) synchronization with the target BS 450 and receives parameters to be used in a downlink and an uplink (UL) in step 417. Thereafter, the MS 400 must perform an operation of acquiring uplink synchronization and adjusting transmission power by performing a ranging operation with the target BS 450. Therefore, the MS 400 transmits a Ranging Request (RNG-REQ) message to the target BS 450 in step 419, and the target BS 450 transmits a Ranging Response (RNG-RSP) message to the MS 400 in response to the RNG-REQ message in step 421.

In the current IEEE 802.16e communication system, when an MS performs handover from a serving BS to a target BS, it is possible to minimize a service delay due to the handover by minimizing a handover process between the serving BS and the target BS through a backbone network. To this end, it is provided that the serving BS or the target BS provides the MS with information indicating processes that may be omitted among the processes necessary for the MS and handover of the MS, using a 1-byte Handover (HO) Process Optimization field. A format of the HO Process Optimization field will now be described with reference to Table 1.

TABLE 1

| Bit # | Description |
|---|---|
| 0 | Omit SBC-REQ/RSP management message during current re-entry |
| | processing |
| 1 | Omit PKM-REQ/RSP management messages during current |
| | re-entry processing |
| 2 | Omit REG-REQ/RSP management message during current re-entry |
| | processing |
| 3 | Omit Network Address Acquisition management messages during |
| | current re-entry processing |
| 4 | Omit Time of Day Acquisition management messages during |
| | current re-entry processing |
| 5 | Omit TFTP management message during current re-entry |
| | processing |
| 6 | Full service and operational state transfer or sharing between |
| | serving BS and target BS (ARQ, timers, counters, MAC |
| | state machines, etc.) |
| 7 | Post-HO re-entry MS DL data pending at target BS |

As shown in Table 1, the HO Process Optimization field includes 1 byte, i.e., 8 bits of bit#0 through bit#7, and is used to indicate whether the MS should perform various necessary processes while it is performing a network re-entry operation. Each of the 8 bits indicates whether the MS can omit each of the necessary processes while it is performing the network re-entry operation with a target BS after performing handover from a serving BS to the target BS. A description will now be made of information indicated by each of the bits.

First, bit#0 indicates whether to omit transmission/reception of Subscriber Station Basic Capability Request (SBC-REQ) message/Subscriber Station Basic Capability Response (SBC-RSP) message between a target BS and an MS. bit#0=‘0’ indicates that transmission/reception of the SBC-REQ message/SBC-RSP message will be performed between the target BS and the MS, and bit#0=‘1’ indicates that transmission/reception of the SBC-REQ message/SBC-RSP message will not be performed between the target BS and the MS.

Second, bit#1 indicates whether to omit transmission/reception of Privacy Key Management Request (PKM-REQ) message/Privacy Key Management Response (PKM-RSP) message between a target BS and an MS. bit#1=‘0’ indicates that transmission/reception of the PKM-REQ message/PKM-RSP message will be performed between the target BS and the MS, and bit#1=‘1’ indicates that transmission/reception of the PKM-REQ message/PKM-RSP message will not be performed between the target BS and the MS.

Third, bit#2 indicates whether to omit transmission/reception of Registration Request (REG-REQ) message/Registration Response (REG-RSP) message between a target BS and an MS. bit#2=‘0’ indicates that transmission/reception of the REG-REQ message/REG-RSP message will be performed between the target BS and the MS, and bit#2=‘1’ indicates that transmission/reception of the REG-REQ message/REG-RSP message will not be performed between the target BS and the MS.

Fourth, bit#3 indicates whether to omit transmission/reception of Network Address Acquisition management messages between a target BS and an MS. bit#3=‘0’ indicates that transmission/reception of the Network Address Acquisition management messages will be performed between the target BS and the MS, and bit#3=‘1’ indicates that transmission/reception of the Network Address Acquisition management messages will not be performed between the target BS and the MS. Herein, the Network Address Acquisition management messages refer to the messages required by the MS to acquire a network address from the target BS.

Fifth, bit#4 indicates whether to omit transmission/reception of Time Of Day Acquisition management messages between a target BS and an MS. bit#4=‘0’ indicates that transmission/reception of the Time Of Day Acquisition management messages will be performed between the target BS and the MS, and bit#4=‘1’ indicates that transmission/reception of the Time Of Day Acquisition management messages will not be performed between the target BS and the MS. Herein, the Time Of Day Acquisition management messages refer to the messages required by the MS to newly acquire time information from the target BS.

Sixth, bit#5 indicates whether to omit transmission/reception of Trivial File Transfer Protocol (TFTP) management messages between a target BS and an MS. bit#5=‘0’ indicates that transmission/reception of the TFTP management messages will be performed between the target BS and the MS, and bit#5=‘1’ indicates that transmission/reception of the TFTP management messages will not be performed between the target BS and the MS. Whether to apply the processes related to bit#3, bit#4 and bit#5 to the MS is determined depending on a type of the MS. However, it will be assumed herein that the processes are applied to all MSs regardless of types of the MSs.

Seventh, bit#6 indicates whether an MS can directly perform a normal service in a target BS without any additional process between the MS and the target BS because a serving BS transmits information on the service previously provided to the MS in the serving BS and its operation state information to the target BS or the BSs share the information. bit#6=‘1’ indicates that the MS can directly perform a normal service in the target BS without any additional process between the target BS and the MS.

Finally, bit#7 indicates whether a target BS is buffering the downlink data to be transmitted to an MS after the MS performs handover. bit#7=‘1’ indicates that the target BS is buffering the downlink data to be transmitted to the MS after the MS performs handover.

An embodiment of the present invention uses bit#6 as information for transmitting/receiving ARQ reset information. That is, bit#6=‘1’ indicates that a target BS holds the intact MS's ARQ signal transmission/reception information previously managed in a serving BS, and bit#6#‘1’ indicates that the target BS requires ARQ reset information because it failed to receive the MS's ARQ signal transmission/reception information previously managed in the serving BS. Herein, the term “ARQ signal transmission/reception” refers to an operation of transmitting/receiving a signal using the ARQ scheme, and the term “ARQ reset” indicates that all information related to the ARQ signal transmission/reception is reset.

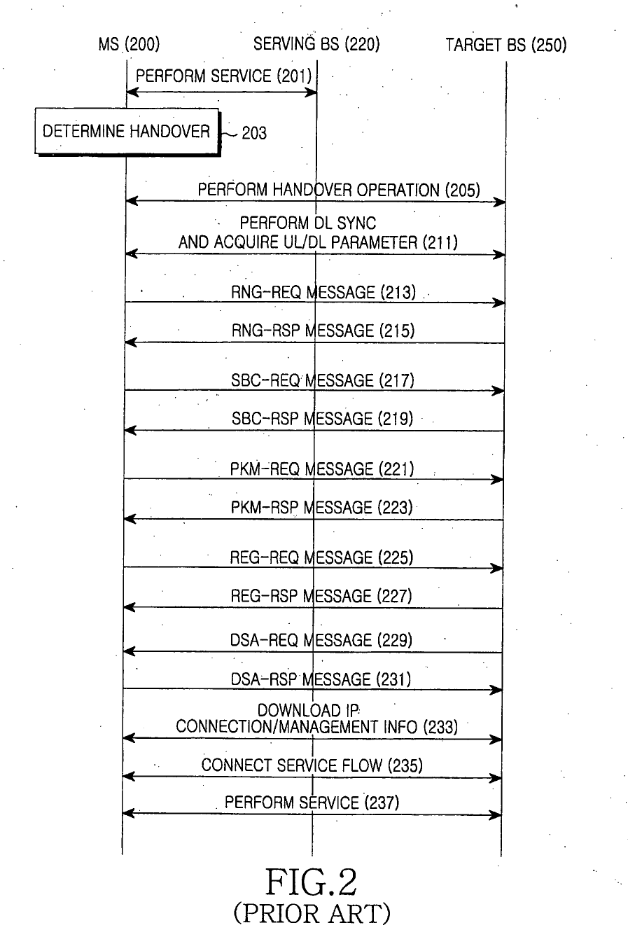

Referring back to FIG. 4, the RNG-RSP message described in step 421 includes therein the HO Process Optimization field, and bit#6 of the HO Process Optimization field is used as proposed in an embodiment of the present invention. Therefore, the MS 400 determines in step 423 whether bit#6 of the HO Process Optimization field included in the RNG-RSP message is set to ‘1’. If it is determined that bit#6 of the HO Process Optimization field is set to ‘1’, the MS 400 performs an ARQ signal transmission/reception operation in step 425 by activating an ARQ state machine. In order to perform the ARQ signal transmission/reception operation, a service flow is actually connected as described in connection with FIG. 2. However, it should be noted that additional processes required for connecting the service flow after receiving the RNG-RSP message is not separately illustrated in FIG. 4 in order to focus the description on the ARQ reset operation. Particular processes among the additional processes required for connecting the service flow after receiving the RNG-RSP message can be omitted depending on each of the bits in the HO Process Optimization field, and a description thereof will not be given herein.

However, if it is determined in step 423 that bit#6 of the HO Process Optimization field included in the RNG-RSP message is not set to ‘1’, the MS 400 transmits an ARQ reset message to the target BS 450 in step 427. As the MS 400 transmits the ARQ reset message, an ARQ reset operation is performed between the MS 400 and the target BS 450 in step 429. Similarly, in order to perform the ARQ reset operation, the service flow is actually connected as described in connection with FIG. 2.

As can be understood from the foregoing description, an embodiment of the present invention uses bit#6 of the HO Process Optimization field for transmission/reception of ARQ reset information, thereby preventing an MS from performing an unnecessary ARQ signal transmission/reception operation after performing handover. The prevention of the unnecessary ARQ signal transmission/reception operation of the MS contributes to preventing resource waste and service delay.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting Automatic Repeat reQuest (ARQ) reset information by a target base station (BS) in a communication system, the method comprising the steps of:
detecting handover of a mobile station (MS); and
transmitting ARQ reset information representative of information related to ARQ reset, to the MS.

2. The method of claim 1, wherein the ARQ reset information includes information indicating that the MS can use intact ARQ signal transmission/reception information previously used before handover.

3. The method of claim 1, wherein the ARQ reset information includes information indicating that the MS should perform an ARQ reset operation.

4. A method for transmitting Automatic Repeat reQuest (ARQ) reset information by a target base station (BS) in a communication system, the method comprising the steps of:
receiving a ranging request message from a mobile station (MS) that performed handover to the target BS; and
transmitting a ranging response message including ARQ reset information representative of information related to ARQ reset in response to the ranging request message.

5. The method of claim 4, wherein the step of transmitting a ranging response message comprises the step of transmitting the ranging response message after expressing a value of a particular bit among a plurality of bits of a handover process optimization field included in the ranging response message, as the ARQ reset information.

6. The method of claim 5, wherein if the particular bit value is set to a predetermined value, the ARQ reset information includes information indicating that the MS can use intact ARQ signal transmission/reception information previously used before handover.

7. The method of claim 5, wherein if the particular bit value is not set to a predetermined value, the ARQ reset information includes information indicating that the MS should perform an ARQ reset operation.

8. A method for receiving Automatic Repeat reQuest (ARQ) reset information by a mobile station (MS) in a communication system, the method comprising the steps of:
performing handover to a target base station (BS); and
after performing handover to the target BS, receiving ARQ reset information representative of information related to ARQ reset, from the target BS.

9. The method of claim 8, wherein the ARQ reset information includes information indicating that the MS can use intact ARQ signal transmission/reception information previously used before handover.

10. The method of claim 8, wherein the ARQ reset information includes information indicating that the MS should perform an ARQ reset operation.

11. A method for receiving Automatic Repeat reQuest (ARQ) reset information by a mobile station (MS) in a communication system, the method comprising the steps of:
after performing handover to a target base station (BS), transmitting a ranging request message to the target BS; and
after transmitting the ranging request message, receiving a ranging response message including ARQ reset information representative of information related to ARQ reset.

12. The method of claim 11, wherein the ARQ reset information is expressed with a value of a particular bit among a plurality of bits of a handover process optimization field included in the ranging response message.

13. The method of claim 12, wherein if the particular bit value is set to a predetermined value, the ARQ reset information includes information indicating that the MS can use intact ARQ signal transmission/reception information previously used before handover.

14. The method of claim 12, wherein if the particular bit value is not set to a predetermined value, the ARQ reset information includes information indicating that the MS should perform an ARQ reset operation.

15. A system for transmitting/receiving Automatic Repeat reQuest (ARQ) reset information in a communication system, the system comprising:
a target base station (BS) for, upon detecting handover of a mobile station (MS), transmitting ARQ reset information representative of information related to ARQ reset to the MS; and
the MS for receiving the ARQ reset information from the target BS, after performing handover to the target BS.

16. The system of claim 15, wherein the ARQ reset information includes information indicating that the MS can use intact ARQ signal transmission/reception information previously used before handover.

17. The system of claim 15, wherein the ARQ reset information includes information indicating that the MS should perform an ARQ reset operation.

18. A system for transmitting/receiving Automatic Repeat reQuest (ARQ) reset information of a base station (BS) in a communication system, the system comprising:
a target BS for, upon receiving a ranging request message from a mobile station (MS) that performed handover to the target BS, transmitting a ranging response message including ARQ reset information representative of information related to ARQ reset in response to the ranging request message; and
the MS for transmitting the ranging request message to the target BS after performing handover to the target BS, and after transmitting the ranging request message, receiving a ranging response message including the ARQ reset information.

19. The system of claim 18, wherein the target BS transmits the ranging response message after expressing a value of a particular bit among a plurality of bits of a handover process optimization field included in the ranging response message, as the ARQ reset information.

20. The system of claim 19, wherein if the particular bit value is set to a predetermined value, the ARQ reset information includes information indicating that the MS can use intact ARQ signal transmission/reception information previously used before handover.

21. The system of claim 19, wherein if the particular bit value is not set to a predetermined value, the ARQ reset information includes information indicating that the MS should perform an ARQ reset operation.
